(19) United States
(12) Patent Application Publication
(10) Pub. No.: US 2008/0203699 A1
(43) Pub. Date: Aug. 28, 2008

(54) HANDLEBAR MOUNT SHOCK ABSORBER STRUCTURE

(76) Inventor: RICH ORIN TRUCHINSKI, Corona, CA (US)

Correspondence Address: BUHLER ASSOCIATES;BUHLER, KIRK A., 1101 CALIFORNIA AVE., SUITE 208, CORONA, CA, 92881, US

(21) Appl. No.: 12/117,156

(22) Filed: May 8, 2008

Related U.S. Application Data
(63) Continuation-in-part of application No. 10/954,694, filed on Sep. 30, 2004, now abandoned.
(60) Provisional application No. 60/507,757, filed on Sep. 30, 2003.

(51) Int. Cl. B62K 21/14

(52) U.S. Cl. 280/276

(57) ABSTRACT

A handle bar mount for small vehicles and of the type having a pivoting handlebar cradle (24) attached to a top member (50) that is attached to a vehicle (20). A series of absorbers (38) is retained by absorber posts (42) using two independent pivot locations. The location of the pivots is ideally suited rearward and lower than the handlebar clamp. This provides a simple and cost effective dampening of vibration from the ground, acceleration, and breaking to the handlebars and the rider. The independent nature of the two pivoting locations allows a rider to lift on one end of the handlebars and push down on the other end of the handlebar and achieve different cushioning and control at each end of the handlebars.

### CROSS REFERENCE TO RELATED APPLICATION

This application is a continuation-in-part of applicant's co-pending application Ser. No. 10/954,694 filed Sep. 30, 2004 which claims priority to provisional application Ser. No. 60/507,757 filed Sep. 30, 2003 the entire contents of which is hereby expressly incorporated by reference herein.

### FIELD OF THE INVENTION

This invention relates to improvements in handlebar mounts. More particularly the handlebar mounts are used for cushioning steering small vehicles such as a motorcycle. More specifically providing a shock absorbing mounting to handlebars that reduces some of the vibration from the ground to the rider.

### BACKGROUND OF THE INVENTION

Traditional ATV, bicycle and motorcycle handlebar mounting structures have for the most part utilized a solid mount handlebar cradle molded into the top steering member. Other designs include a solid bolted mounting interface between the upper steering member and handlebar cradles providing in some cases adjustment of handle bar position but no vibration or impact damping.

A significant improvement came when rubber bushings were included in a motorcycle handle bar cradle mount that was bolted to the top member using rubber bushings to insulate the vibration. Although the design is helpful during long periods of usage in reducing vibration transmitted to the handlebars, it has minimal effect on large impacts due to the minimal capacity for deformation of the bushings.

Other prior inventions have used mechanical hydraulic shock absorbing system that requires the use of highly precision machined telescoping tubes, seals, and fluid that must be contained in a sealed unit and requires maintenance to minimize fluid leaks.

U.S. Pat. No 6,712,541 Henricksen (2004) discloses a triple clamp plus a handlebar clamp. This invention uses multiple dampers, but the dampers do not pivot on the clamp mechanism, the dampers provide rocking and normal damping of the handlebar. This invention also requires at least three clamps plus a handlebar clamp to operate.

U.S. Pat. No 6,371,263 Hoose (2002) discloses a dampening system with springs and hydraulic fluid that provides the dampening. This invention uses multiple dampers, but the dampers do not pivot on the clamp mechanism, the dampers provide only normal forces to be applied to the dampers. This provides dampening when the handlebars are being pushed down, but provides minimal damping when the rider is accelerating. The assembly is also expensive and prone to leaking hydraulic fluid.

U.S. Pat. No. 5,511,444 Clausen and Allsop (1996) disclosed a system, which utilized parallel mounted arms and a damper unit. This patent describes using a shock absorbing bicycle handlebar assembly. This design requires the use of four pivots, which increased the complexity, and cost of the unit.

U.S. Pat. No. 6,325,402 B1 Gogo and Wakamatsu (2001) disclose a system, which utilizes a spring and shock to dampen vibrations and impacts. This patent describes using a spring and shock damping design. This design makes it possible to absorb down ward impacts and general vibrations. However it is less effective in absorbing forward impacts that are transmitted to the operator as a result of hard braking. Another disadvantage is the use of guide slots to limit travel of the handlebar holder that can reduce the damping of impacts and vibration to the handlebars at full travel and in an acceleration direction it does not provide any additional damping. In addition, the use of a cylindrical member for means of preload adjustment to the coil spring extends above the handlebar mount, which could result in a safety problem for the rider in the event of an accident. The Gogo patent only allows for downward cushioning and does not provide for forward arc cushioning motion.

Still other prior inventions have used a hard stop to limit movement of the handlebar cradle the proposed structure minimizes the impact that is transmitted to the operator when the handlebar cradle reaches full travel. As the force is increased the absorber overcomes the force of the impact at a progressive rate rather that stopping on a positive hard stop.

### BRIEF SUMMARY OF THE INVENTION

It is an object of the pivotal handlebar mounting structure to incorporate a pivoting handlebar cradle and a series of absorbers to create damping of vibration and impacts to the handlebars of a popular ATV, motorcycle or bicycle during operation and more specifically jumps, bumps de-acceleration and acceleration.

One feature of the present handlebar mount shock absorber is the provision of a top member adapted to fit and retain a pair of forks or steering housing as a foundation for means of handlebar support.

In accordance with this object of the present handlebar mount shock absorber is a pair of pivotally attached handlebar cradles mounted to the top member creating a secondary suspension for the handlebar cradles. The pair of cradles allows a rider to lift one end of the handlebar and press down on the opposite handle bar and achieve different cushioning on each end of the handlebar.

In accordance with this object of the present handlebar mount shock absorber the pivot exists rearward and lower than the handlebar clamp. The pivot allows for arc motion in both directions and particularly forward arc motion.

In accordance with this object of the present handlebar mount shock absorber is the provision of a series of absorber units fitted between and around the handlebar cradles and top member providing damping of vibration and impacts transmitted from the suspension to the handlebars. The use of the rubber absorbers will permit the use of the original handlebar and handlebar padding due to the location and size of the absorbers.

In accordance with this object of the present handlebar mount shock absorber is the provision of a structure to retain said series of absorbers in place and to provide additional strength of the cradles when normal directional forces are applied as well as when lateral forces are applied. The opposing absorbers can be made stiffer or softer in compound and density as well as different shapes to control the movement of the handlebar. Additional bushing can be used at the handlebar cradle pivot minimizes the vibrations transmitted to the operator during operation.

It is another object of the pivotal handlebar mount for each handlebar cradle and a series of opposing bumpers that allows movement in a forward downward and upward backward direction which can absorb impacts transmitted from off road terrain without sacrificing the steering accuracy of the vehicle and is more suitable to the natural direction of the rider operator movement with minimal components and cost to the manufacture. The presence of the opposing absorbers allows cushioning in both an acceleration direction when the vehicle is under full throttle for example and in a braking direction when entering corners. It allows movement of the handlebar when braking to absorb the bumps and potholes that usually occur when that section of the terrain has many vehicles traveling and braking at the same point.

Various objects, features, aspects, and advantages of the present handlebar mount shock absorber will become more apparent from the following detailed description of preferred embodiments of the handlebar mount shock absorber, along with the accompanying drawings in which like numerals represent like components.

### BRIEF DESCRIPTION OF THE DRAWINGS

FIG. 1 is a perspective view of a motorcycle incorporating the present handlebar mount shock absorber.

FIG. 2 is a right side view of the present handlebar mount shock absorber removed.

FIG. 3 is a top view of the present handlebar mount shock absorber top member with handlebar cradles removed.

FIG. 4 is a lower perspective view of the present handlebar mount shock absorber removed.

FIG. 5 is a top perspective view of the present handlebar mount shock absorber removed.

FIG. 6 is a left side part view of an alternate embodiment of the present handlebar mount shock absorber configured for securing on an original equipment top clamp.

FIG. 7A-C shows the operation of the present handlebar mount shock absorber.

FIG. 8A-B shows cross sectional views of the absorbers in a neutral and compressed condition and shows the optional conical relief area for the absorbers.

### DRAWINGS

### Reference Numerals

| | | | |
|---|---|---|---|
| 20 | motorcycle | 21 | Mounting base |
| 22 | handlebar | 23 | Original equipment top member |
| 24 (a, b) | handlebar cradle bottom | 26 | upper fork tube |
| 28 | front wheel | 30 (a, b) | handlebar cradle top |
| 32 (a, b) | handlebar pinch bolt | 33 | Bolt |
| 34 | lower fork tube | 35 | Bolt |
| 36 (a, b, c, d) | washer | 38 (a, b, c, di) | absorber |
| 40 (a, b, c) | retaining nut | 42 (a, b) | absorber post |
| 44 | pocket area | 46 (a, b, c, d) | handlebar cradle pivot |
| 48 (a, b) | handlebar clamping area | 50 | top member |
| 56 (a, b) | absorber post bore | 58 | bottom member |
| 60 (a, b) | fork tube clamping area | 62 | steering stem bore |
| 64 (a, b) | pinch clamp slot | 66 (a, b) | slot |
| 68 (a, b) | pin | 70 (a, b) | bolt |
| 72 | bushing | 74 | suspension assembly |
| 76 | hydraulic damper | 80 (a, b, c) | pivot locations |
| 82 | cup | 84 | bulge |

### DETAILED DESCRIPTION

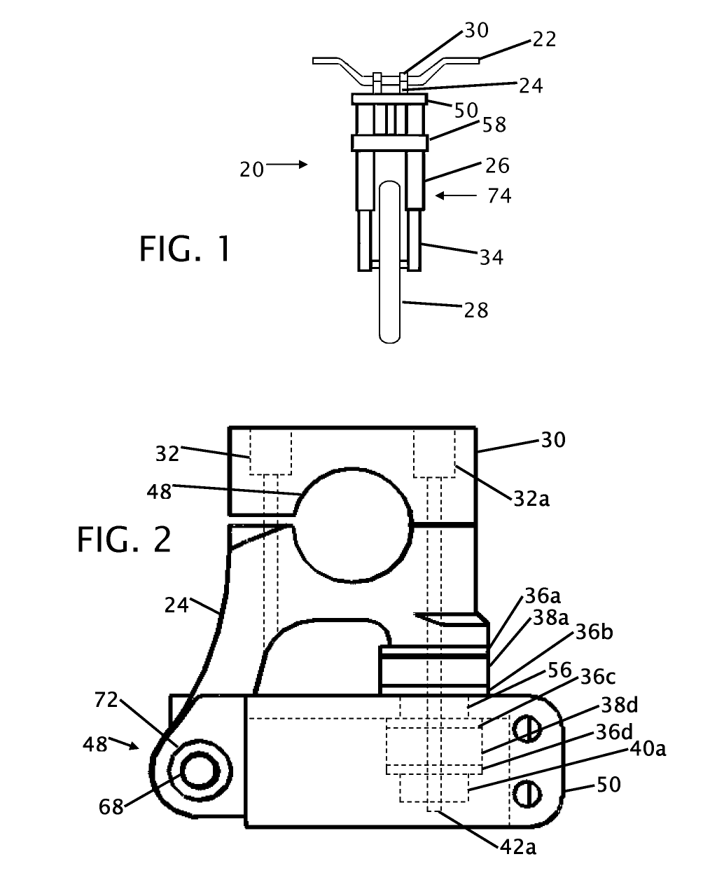

FIG. 1 shows a perspective view of a motorcycle incorporating a preferred embodiment of the handlebar mount shock absorber. A front prior art suspension assembly 74 has a bottom member 58 and a top member 50 pivotally connectable to the motorcycle 20 and a pair of telescoping upper fork tube 26 and lower fork tube 34 sets. A front wheel 28 is connected to the pair of lower fork tubes 34. A pair of handlebar cradle bottoms 24 is pivotally attached to top member 50. The pair of handlebar cradle bottoms is symmetrical and is mounted in a direction of the width of the motorcycle. Each handlebar cradle bottom 24a is connected via a handlebar cradle pivot 46a as shown in FIG. 2, to the top member 50 which allows movement of a handlebar 22 retained by a pair of handlebar cradle tops 30 and a series of handlebar pinch bolts 32a, 32b shown in FIG. 2. An absorber post 42a extends through a corresponding absorber post bore 56 to the lower side of top member 50. A set of upper 38a and lower 38d absorbers is held in place by absorber post 42a and a retaining nut 40a to create damping of vibrations and impacts during acceleration, braking and maneuvering obstacles for example, on off road terrain. A series of washers 36a, b, c, d provide a maintainable surface for absorbers 38a, 38d to interface with. The nut 40a can be threaded onto the absorber posts 42a to increase the preload on the absorbers and provide firmer handlebar response. It is also possible to loosen the nut 40a to allow for some free travel of the handlebar before the free travel comes in contact with either the upper 38a or the lower 38d absorber.

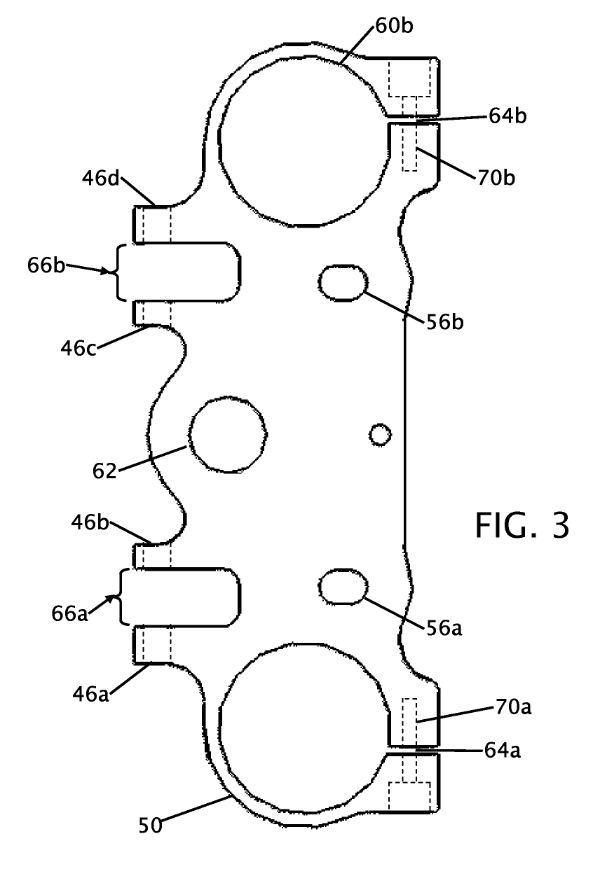

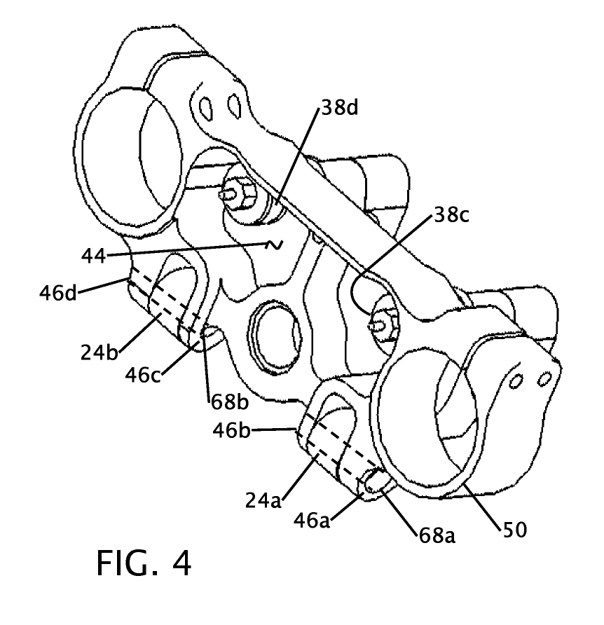

FIG. 3 shows top member 50 with handlebar cradle bottoms removed to show a pair of slots 66a, 66b where the handlebar cradle bottoms attach and their relationship to absorber post bore 56a, 56b and steering stem bore 62. Each slot 66a, 66b is an area for the handlebar cradle bottom to fit between, providing areas for handlebar cradle pivot 46a, 46b, 46c, and 46d to be machined where pins 68a, 68b are located as shown in FIG. 4. Pins 68a, 68b could be a threaded bolt, solid pin or hollow pin, referring back to FIG. 3. Fork tube clamping area 60a, 60b retains upper fork tube when bolt 70a, 70b is tightened closing pinch clamp slot 64a, 64b until top member 50 is holding upper fork tubes 26 as shown in FIG. 1 secure. This is the most common method the motorcycle manufactures use to retain upper fork tubes shown in FIG. 4.

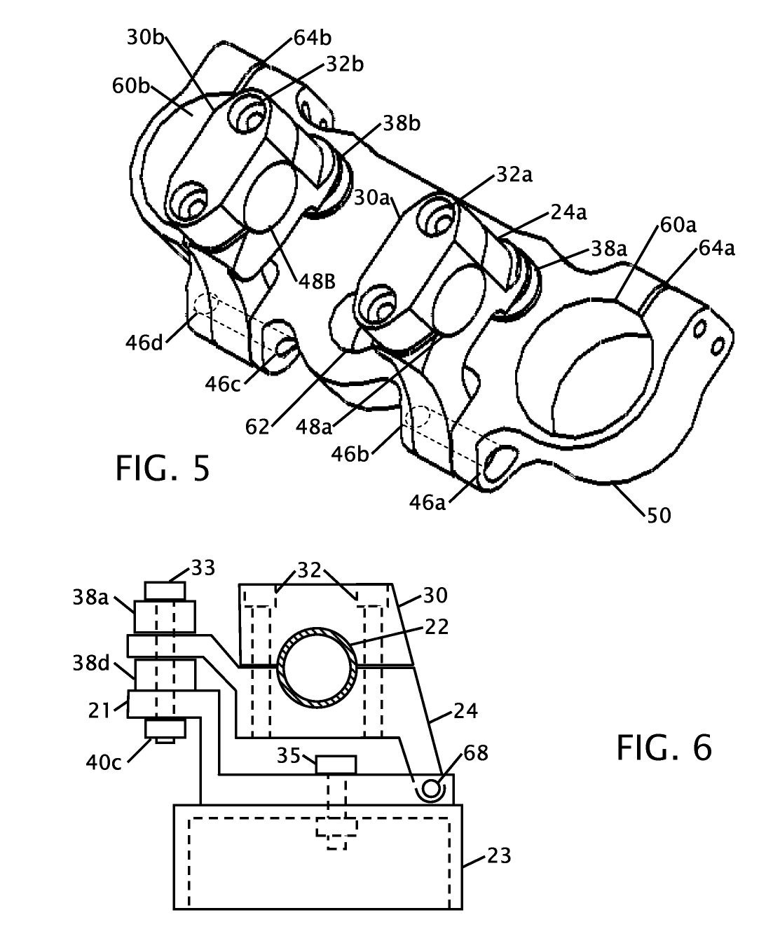

The bottom of top member 50 (FIG. 4) has a pocket area 44 where each lower absorber 38c, 38d is located. This bushing can be made of plastic, rubber, brass, bronze, aluminum, or a combination of these materials or other materials that provide similar results. Pocket area 44 is an area that allows deformation of each absorber 38c, 38d. This also applies to the open area on the upper side of top member 50 shown in FIG. 5, where the upper absorbers 38 are located. This in turn allows each respective handlebar cradle bottom to move depending on the hardness and shape of absorber 38a, 38b, 38c, 38d shown in FIGS. 4 and 5. In FIG. 3 the absorber bore hole 56 is elongated to allow the absorber post 42a to swing within the bore hole 56 as the top and bottom handle cradle pivots on the top member 50. The material composition, hardness and shape of each absorber 38a, 38b, 38c, and 38d can be changed to control the movement of handlebar cradle bottom 24 shown in FIG. 1. For example they could be rubber, polyurethane or any combination of a rubberized plastic composition that would aid in the proper amount of absorption for the given environment. In addition to the shape of absorber 38a, 38b, 38c, 38d, the shape of washer 36a, 36b can be changed likewise to also aid in the control of the handlebar cradle bottom 24. In FIG. 2 the absorbers 38a, 38b, 38c, 38d are square shaped. FIG. 5 shows that two separate and independent pivoting handlebar clamps are being used. The independent nature of the two pivoting locations allows a rider to lift on one end of the handlebars and push down on the other end of the handlebar and achieve different cushioning and control at each end of the handlebars.

FIG. 6 is a right side view of an alternate embodiment of the present handlebar mount shock absorber is configured for securing on an original equipment top member. The mounting base 21 is configured to bolt 35 directly onto an original equipment top member 23 that is present on most motorcycles. A stock or custom handlebar 22 is clamped into the handlebar mount shock absorber with handlebar pinch clamps 32 that clamp the handlebar between the handlebar cradle top 30 and the handlebar cradle bottom 24. The sub assembly of the top and bottle handlebar clamp 24 and 30 is pivotally secured to the mounting base 21 with a pin 68 that allows the handlebar 22 to move/rotate independently from the original equipment top member 23. A bolt 33 extends through a bore in the handlebar cradle bottom 24 and then is secured into mounting base 21. There is an upper absorber 38a that absorbs lifting motion of the handlebar 22 and a lower absorber 38d that absorbed downward motion of the handlebar 22. The bolt 33 can be loosened from the nut 40 can be threaded onto the absorber posts 42a to increase the preload on the absorbers and provide firmer handlebar response. It is also possible to loosen the retaining nut 40c to allow for some free travel of the handlebar, if desired by a user, before the free travel comes in contact with either the upper 38a or the lower 38d absorber.

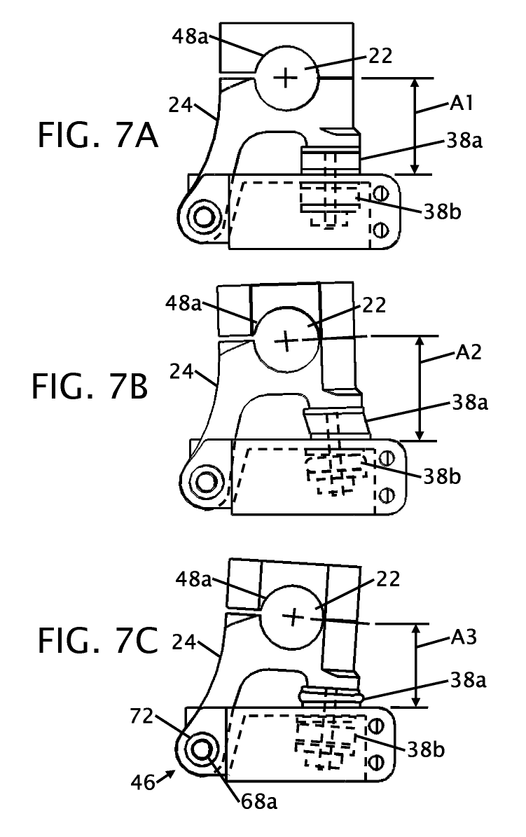

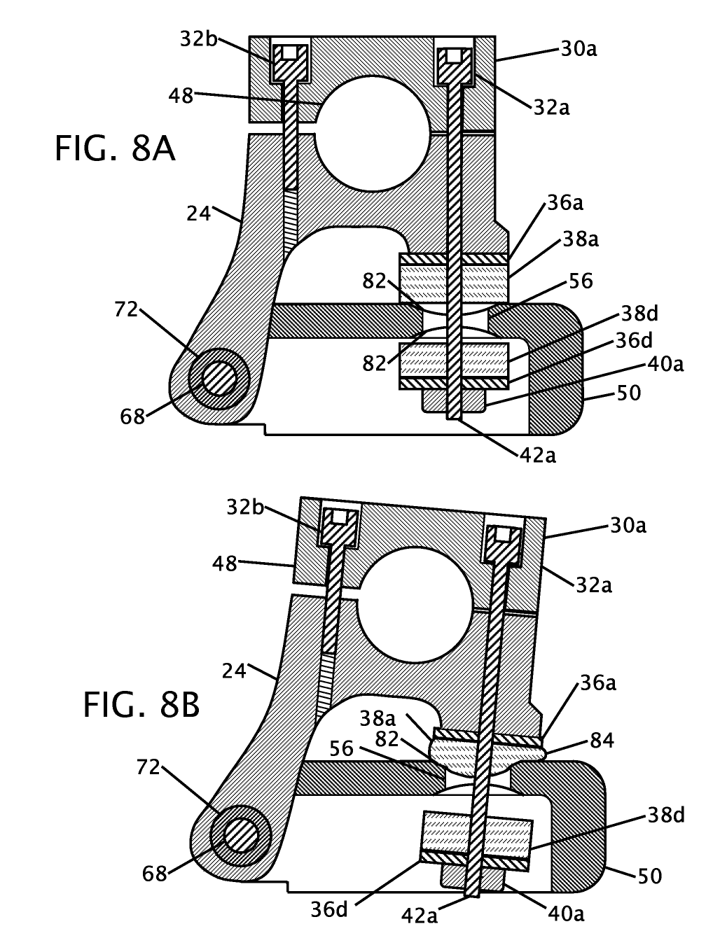

The operation of the handlebar mount shock absorber structure is shown in FIGS. 7A-C. FIG. 7A shows a state where external force is not applied to the handlebar and where distance “A1” is the neutral position. FIG. 7B shows the lower absorber 38b in compression for example when the bike is accelerating and the rider is pulling on the handlebar 22 in handlebar cradle 24. This action absorbs the impact felt by the rider and distance “A2” has increased in an upward and rearward direction. The handle mount exhibits a forward arc motion where lower absorbers 38b absorb load variations while still maintaining control over the steering and the motorcycle. FIG. 7C shows the upper absorber 38a in compression when the rider and bike are decelerating or landing from a jump. Distance “A3” has decreased whereby absorbing the force in a downward and forward direction. In both FIGS. 7B and 7C the absorbers 38a that are under compression are unconstrained from side expansion. The upper and lower opposing absorbers each have different absorption properties to control movement of said handlebars. The handle mount exhibits a rearward arc motion where upper absorbers 38a absorb impacts. As an example the upper absorbers would be firmer to provide control in acceleration while the lower absorbers would be softer to absorb ground impacts. The expansion of an absorber is shown and described in more detail in FIGS. 8A and 8B.

FIGS. 8A-B shows cross sectional views of the absorbers in a neutral and compressed condition and shows the optional conical relief area for the absorbers. FIG. 8A shows the handlebar mount shock absorber system in a neutral unloaded condition. The top member 50 would be mounted to a vehicle as previously described. A bushing 72 connects to a pin 68 to allow for rotational movement of the lower handlebar cradle 24 on the top member 50. The lower handlebar cradle is bolted to elongated handlebars 22 (shown in FIG. 1) with a handlebar top cradle 30 using bolts 32 and 32a or equivalent fasteners. The bolt 32a extends as an absorber post 42a through the lower handlebar cradle 24, through washer 236a, absorber 38a, top member 50, absorber 38d, and washer 36d where it is fastened with a nut or similar fastener 40a. The fastener 40a can be a variety of fasteners that will not back-off the absorber post 42a when vibrated. Acceptable fasteners would include but not be limited to Nylon insert nuts, castle nuts, slotted nuts, locknuts, tamper resistant nuts and expanding nuts. The faces where the absorbers 38a and 38d mate with the upper and lower faces of the top member 50 are cupped 82 to allow each absorber 38a or 38d to expand into. The absorber bore hole 56 is elongated (as shown in FIG. 3) to allow the absorber post 42a to swing within the bore hole 56 as shown in FIG. 8B.

In FIG. 8B the upper 30 and lower 24 handlebar cradles are shown rotated with absorber 38a pressed into the cup 82 and bulging 84 out the sides without being constrained from expansion. The cups 82 allow for a softer initial compression because the absorbers can initially expand into the cups 82 before they expand or bulge 84 out the sides. The cups may exist on one or both sides of the top member 50 and the existence or absence of the cup(s) 82 alter the cushioning from the absorbers 38a and 38d. Because the absorber post 42a is threaded the fastener 40a can be turned up or down the length of the absorber post 42a to create a preload on the absorbers 38a, 38d to stiffen the cushioning. It is also possible to loosen the fastener 40a and allow for free travel of the handlebar cradle before the free travel contacts an absorber 38a, 38d. This free travel is shown in FIG. 8A as a gap existing between the absorber 38d and top member 50.

Thus, specific embodiments of a pivoting motorcycle handlebar have been disclosed. It should be apparent, however, to those skilled in the art that many more modifications besides those described are possible without departing from the inventive concepts herein. The inventive subject matter, therefore, is not to be restricted except in the spirit of the appended claims.

What is claimed is:

1. A handlebar mount shock absorber structure for a vehicle comprising:
a top member for attachment to a vehicle having two separate fork tube clamps for attachment to forks of said vehicle and one steering stem bore hole for a fastener to secure said top member to a steering stem of the vehicle;
a first handlebar cradle clamp for securing elongated handlebars through said first handlebar cradle clamp that is pivotally hinged to said top member;
a second handlebar cradle clamp that is independent from said first handlebar cradle for securing said elongated handlebars through said second handlebar cradle clamp that is pivotally hinged to said top member; wherein
said pivotal axis of said first handlebar cradle and said pivotal axis of said second handlebar cradle are two co-linear independent handlebar cradle pivot attachment points for attaching and securing said first handlebar cradle and said second handlebar cradle to the top member to allow said first handlebar cradle to pivot independently from said second handlebar cradle to allow said handlebar cradles to rotate in the same or opposite directions, and
independent absorbers above and below said top member on said first handlebar cradle and independent absorbers above and below said second handlebar cradle to cushion rotation of said elongated handlebar with said top member.

2. The handlebar mount shock absorber structure from claim 1 wherein said vehicle is an ATV, bicycle, motorcycle.

3. The handlebar mount shock absorber structure from claim 1 wherein said absorbers are shaped round, cylindrical, pyramid, toroidal.

4. The handlebar mount shock absorber structure from claim 1 wherein said handlebar cradle pivot is pivotally attached to said first and second handlebar cradles is a position that is lower than said handlebars and allows said cradles to rotate in both a rearward and a forward arc motion.

5. The handlebar mount shock absorber structure from claim 1 wherein said at least one absorber is replaceable or changeable.

6. The handlebar mount shock absorber structure from claim 1 wherein said upper and lower opposing absorbers each have different absorption properties to control movement of said handlebars.

7. A handlebar mount shock absorber structure for a vehicle comprising:
a top member for attachment to a vehicle;
two separate and independent handlebar cradle clamps for securing an elongated handlebar through said two separate and independent handlebar cradle clamps;
two co-linear independent handlebar cradle pivot attachment points for attaching and securing said two separate and independent handlebar cradle clamps to allow said first handlebar cradle to pivot independently from said second handlebar cradle;
at least two absorbers on each of said separate and independent handlebar cradle clamps wherein one of said absorbers absorbs rotation in a first direction of rotation of each of said separate and independent handlebar cradle, and a second said absorbers absorbs rotation in a direction that is opposite of said first direction of rotation, and
said first and said second absorbers provide different amounts of absorption to provide shock absorption in said first direction of rotation and rebound control in said second direction of rotation.

8. The handlebar mount shock absorber structure from claim 7 wherein said vehicle is an ATV, bicycle, motorcycle.

9. The handlebar mount shock absorber structure from claim 8 wherein said absorbers are shaped round, cylindrical, pyramid, toroidal.

10. The handlebar mount shock absorber structure from claim 7 wherein said top member is a mounting base configured to mount onto an original equipment top member.

11. The handlebar mount shock absorber structure from claim 7 wherein at least one surface that said absorbers contacts is dish shaped to allow said absorber to expand into.

12. The handlebar mount shock absorber structure from claim 7 wherein a pivot axis of said handlebar cradle pivot exists rearward of said handlebar cradle to allow said handlebar cradles to rotate in both a rearward and a forward arc motion.

13. A handlebar mount shock absorber structure for a vehicle, said handlebar mount comprising:
a top member for attachment to a vehicle;
a handlebar cradle pivotally secured to said top member for mounting to handlebars of said vehicle, wherein
an upper and a lower absorber resting on opposing sides of the top member and are secured to said handlebar cradle such that said absorbers are not constrained from radial expansion to independently limit and dampen rotation of said top member and said handlebar cradle in opposing rotational directions where said dampening is by means of compressing said absorber between said top member and said handlebar cradle at a location distal from said handlebar cradle pivot;
said upper and lower absorbers are both connected to said handlebar cradle with a single fastener that is adjustable to increase or decrease compression of said upper and lower absorbers to preload said absorbers on said top member.

14. The handlebar mount shock absorber structure from claim 13 wherein the vehicle is an ATV, bicycle, or motorcycle.

15. The handlebar mount shock absorber structure from claim 13 wherein two separate and independent handlebar cradles are pivotally secured to said top member to allow each said handlebar cradle to independently pivot in the same or opposite directions on said top member.

16. The handlebar mount shock absorber structure from claim 13 wherein said attachment of said top member to the vehicle attachments by means of at least one pinch clamp.

17. The handlebar mount shock absorber structure from claim 13 wherein said absorbers are replaceable and made from material consisting of plastic, rubber, brass, bronze, aluminum, or polyurethane.

18. The handlebar mount shock absorber structure from claim 13 wherein a pivot axis of said handlebar cradle pivot exists rearward of said handlebar cradle to allow said handlebar cradles to rotate in both a rearward and a forward arc motion.

19. The handlebar mount shock absorber structure from claim 13 wherein said top member is a mounting base configured to mount onto an original equipment top member.

20. The handlebar mount shock absorber structure from claim 13 wherein said upper and lower opposing absorbers each have different absorption properties to control movement of said handlebars.
